(19) United States
(12) Patent Application Publication
(10) Pub. No.: US 2024/0166904 A1
(43) Pub. Date: May 23, 2024

(54) Water-based Polymeric Colorant Inks for Cellulosic Substrates

(71) Applicant: Sun Chemical Corporation, Parsippany, NJ (US)

(72) Inventor: Paul Wallace, Derbyshire (GB)

(73) Assignee: Sun Chemical Corporation, Parsippany, NJ (US)

(21) Appl. No.: 18/551,657

(22) PCT Filed: Apr. 1, 2022
(86) PCT No.: PCT/GB2022/050834

§ 371 Date: Sep. 21, 2023

Related U.S. Application Data
(60) Provisional application No. 63/149,407, filed on Feb. 15, 2021.

(51) Int. Cl. C09D 11/322; C09D 11/38

(52) U.S. Cl. CPC C09D 11/322; C09D 11/38

(57) ABSTRACT

The present invention relates to water-based ink composition comprising one or more polymeric colorant(s) and one or more an acid functional polymer(s) that are suitable for inkjet printing, particularly suitable for inkjet printing of fibrous substrates such as textiles.

The present invention relates to water-based ink compositions comprising one or more polymeric colorant(s) and one or more acid functional polymer(s) that are suitable for inkjet printing, particularly for inkjet printing of fibrous substrates such as textiles.

Advantageously, the ink compositions of the present invention improve sustainability in the textile printing industry. In particular, the polymeric colorants that are present in the ink composition can be delivered from renewable (i.e. sustainable) sources and can also be designed and synthesized to have a high degree of biodegradation. Furthermore, the ink compositions of the present invention typically achieve 70% or greater fixation of the ink colorant to the substrate surface meaning that there is less discharge of ink colorant into wastewaters during and after printing, and also upon washing the printed substrate.

### BACKGROUND OF THE INVENTION

Classical formulation approaches to inkjet inks for fibrous substrates use colorants such as water-soluble dyes (e.g. reactive or acid dyes), dispersions of water-insoluble dyes (e.g. disperse dyes), or pigments, which are insoluble in almost all solvents. Dyes exist as single molecules and each dye molecule is able to absorb light and reflect back the light of non-absorbed wavelengths. In a pigment, there could be millions of pigment molecules in a single particle, and for applications such as inkjet printing, the particle sizes are typically in the range of 100-200 nm. Only about 10% of the surface of the pigment particles contain active molecules so pigments tend to be much less vibrant in their tinctorial strength than dyes. This tends to be why dyes (rather than pigments) are still used in applications such as textiles for fashion and home furnishing.

Typically, the colorant is required to bind to a substrate, for example a cellulosic textile, cellulosic paper, leather, wood or even digitally printed wall covering. In the case of dyes, these are typically bound via either a steaming process or a heat transfer (sublimation) process for textiles and a reaction occurs at the dye-textile interface to form a chemical covalent bond. Typically, huge amounts of water and energy are required for this process. Furthermore, for dye-based inks, typically the reaction between the dye and the fabric is only about 70% effective, meaning that about 30% of the dye is washed off during the processing after printing and wasted.

Similarly, for a pigment ink which is printed onto a plastic substrate, the pigment can be either encapsulated with a dispersant polymer or surface modified (for example oxygenated or sulfonated) to form a reactive surface. In all cases, pigment inks require a binder to lock in the pigment particles. In the case of pigments, their application in, for example, industrial textile printing has been fraught with challenges. The most significant are the washfastness of the colorant which is loosely associated with the fabrics and typically physically trapped in a polymer matrix. Furthermore, pigment-based inks that can be used for fibrous substrates have demonstrated poor performance thus far due to inferior washfastness and lower tinctorial strength compared to dyes when printed.

Pigments are the only colorant of choice thus far for substrates such as plastic, non-permeable, metal, etc. However, pigment inks tend to suffer from some instability and potential poor image quality as particles can aggregate and can be difficult to mill down to a size that imparts stability without severely reducing the coloristic qualities of the pigments.

Hence, the problem to be solved when using dye-based inks, is that there is a relatively low yield of fixation to the substrate—perhaps only about 70% in some applications. In addition, the problem to be solved when using pigments is that the colorant, which has a significantly lower tinctorial strength compared to a dye, is only generally loosely associated with the substrate by means of a complex network of binders meaning that the pigment particles can be washed out relatively easily. These problems have not yet been solved in the art.

EP1082396 B1 describes a polymeric colorant that can be dissolved in an organic solvent and printed using inkjet printing onto certain substrates. EP1082396 B1 discloses that the polymeric colorants used must be solvent soluble, whereas the polymeric colorants in the present invention are soluble in water and co-solvent-water mixtures such as glycol co-solvent-water mixtures.

U.S. Pat. No. 8,153,706 B2 relates to a complex dye, pigment and polymer colorant which can be used in inkjet inks. The colorant itself is the primary focus of this patent. The colorant is built up from a pigment, which has a polymer covalently attached to it, and a dye also covalently attached to the polymer. The pigment also has a dispersant covalently attached to it.

EP1056703 B1 describes the synthesis of polymeric colorants incorporating an organic chromophore, a polyisocyanate and either a carboxylic acid or sulfonic acid into a polymeric colorant molecule which is water soluble. EP1056703 B1 specifically describes polymeric colorants containing urethane bonds that can be made into inkjet inks with water, a diluent and a binder. The type of binder used is not disclosed. The patent also describes that the isocyanate-containing polymer reactive groups are particularly good at binding to the —OH groups of paper and textile fabrics. In the present invention, the —OH groups of the polymeric colorant (when present) can be linked with either an ester linker or via a (optional) CDI cross-linker to a binder having acid functionality. The acid functionality of the binder can further react with more CDI cross-linkers (if present) or via an ester linker with the —OH groups of cellulosic substrates and indeed be cured on the surface of such substrates. Furthermore, in EP1056703 B1, the reactive functional groups are isocyanates which are not known for their long storage stabilities and also can decompose leading to incomplete fixation on the substrates.

EP0604024 B1 describes phase change inks (otherwise known as hot-melt inks) that can be ejected from thermal print heads using a colorant which is a disperse, acid or basic dye that contains a least one reactive group and this is printed onto a substrate containing a second reactive component. The colorant typically then undergoes a curing stage, usually radiation-based, to form a chemical bond between the dye and second reactive component. This patent does not use polymeric colorants as the ink component but forms a polymer which is covalently bound to the substrate via the second reactive group on curing.

U.S. Pat. No. 7,732,509 B2 relates to the use of polymeric colorants containing carboxyl (—COOH) groups which can be used to print directly onto paper. This patent does not relate to industrial substrates such as textiles and there is no disclosure of any curing steps. This indicates that the mechanism of action is for the colorant particles to be simply printed onto paper and allowed to air dry in continuous inkjet small office, home office (soho) applications. The focus of this patent is to the use of a single polymeric colorant where the pigment is directly bound to the polymer instead of classically using a pigment and dispersant.

EP0921166 B1 describes that a pigment can be covalently bound to a polymer and this resulting polymeric pigment used in an inkjet ink. This has been the approach of several companies who make dispersions of pigments where traditionally the pigment and dispersant are loosely associated with one another. In the case of this patent, there is a chemical bond between the pigment and the polymer but the resulting polymeric colorant is completely insoluble in aqueous inks and therefore can still be prone to settling and instability.

EP1245588 B1 describes a composite ink formulation containing a colorant phase and a polymer phase, which are immiscible, but the particles only survive for 20 minutes. Clearly this approach can be cited as being an unsuccessful solution to the complex problem which the inventors of this patent intend to address.

EP1405884 B1 discloses that the short-lived particles generated in EP1245588 B1 can be used in an inkjet ink. Clearly, the combination of insoluble particles and short-lived stable particles does not address the current problems in the field that are addressed in the present invention.

Citation or identification of any document in this application is not an admission that such represents prior art to the present invention.

Whilst the manufacture and materials leading to polymeric colorants are described in the art, these materials have not yet been fully exploited in digital inkjet inks, particularly aqueous digital inkjet inks. In addition, in current modern day pigment ink printing methods—adhesion, fastness, and color properties need to be improved in order for mass market adoption, e.g. in the textile industry.

The inventors solve the problems mentioned herein by applying materials designed for use in polyurethane objects in a series of inkjet ink formulations. Specifically, the present invention employs polymeric colorants comprising free hydroxyl (—OH), thiol (—SH) or free amino (—NH₂ or —NHR) groups on the polymer chains in water-based inkjet ink formulations.

### DETAILED DESCRIPTION

The inventors have developed a series of ink formulations using water, one or more acid functional polymer(s) and one or more polymeric colourant(s) (e.g. one or more polymeric dye(s)), wherein the polymeric colorant comprises polymer chains having at least one hydroxyl (—OH), thiol (—SH) or primary or secondary amino (—NH₂ or —NHR) group on the polymer chain, which can be used to bind to certain substrates (e.g. fibrous substrates), in some cases with other, optional, co-binders, in a variety of different applications. The inks according to the present invention work in such a way that the polymeric colorants (e.g. the polymeric dyes) undergo a chemical reaction post-printing with other components of the ink (e.g. the acid functional polymer) to lock the colorant to the substrate via a series of covalent bonds. This means that the colorant is less susceptible to washing off and also demonstrates significantly superior colorant properties. Furthermore, the polymeric dyes in conjunction with the other ink ingredients can be delivered from sustainable sources and are also biodegradable. In addition, the polymeric dyes can also be used in combination with one or more pigment(s) to enhance the colour saturation.

The use of a polymeric colorant in the ink formulations which contains at least one of either free hydroxyl groups (—OH), thiol groups (—SH) or amine groups (—NH₂ or —NHR) is advantageous as these colorants are able to crosslink with other components of the ink, for example the acid functional polymers (which typically function as co-binders), and furthermore they are able to bind to certain functional groups on the surface of the substrate—for example, cellulosic —OH groups, fixing the ink to the surface.

In addition, by covalently binding a dye (or a pigment) to a polymer, which can be deposited onto a substrate by inkjet printing and then covalently bound to the substrate, the tinctorial properties of a dye are maintained, and preferably with 70% or greater fixation, more preferably with greater than 80% fixation, and even more preferably with 100% fixation to the substrate. Furthermore, as the colorant is covalently bound to the substrate it does not suffer the wash off effects often experienced with pigment colorants. This improves the sustainability of the ink composition since the dye or pigment is not washed off during processing or after printing.

Inkjet ink formulations which can be inkjet printed and display a trade-off with all the necessary parameters required from a high-performing ink in the industrial inkjet sector are not known in the art. To this end, the inventors have taken a set of polymeric dyes and prepared ink formulations which on curing lock the colorant to the surface of the substrate and display superior washfastness and resistance after curing compared to conventional dye or pigment inks. This makes the inks according to the invention particularly attractive for use in applications which require high tinctorial strength from the colorants used such as textiles.

The inventive inks are mainly composed of water and can be printed onto a diverse number of different substrates directly. Indeed, it is unexpected that the water-based inks according to the present invention can be printed directly onto a non-treated textile substrate (for example, a non-treated plastic textile substrate such as woven (or non-woven) polyester), but the inks according to the present invention print well and give a good, durable image on these substrates. Furthermore, reliability in the printing press is important. The inks according to the present invention display excellent re-solubility and open time, meaning the printing press can be used for longer periods without any need for preventative maintenance.

The present invention also relates to the use of a polymeric dye as the colorant for a series of digital industrial inkjet inks for a variety of different applications. The inkjet inks comprise one or more polymeric dye(s) as the colorant, one or more acid functional polymer(s), water and at least one organic co-solvent. The inkjet inks perform in a manner which solves the modern day demands from industry for digital inks, including good jetting, sharp image quality, good adhesion, resolubility, ease of maintenance on press, long storage stability and low migratable content when cured, making them potentially useful for printing textiles and wall coverings and other industrial applications.

Whilst the art describes use of polymeric colorants previously in inkjet inks, the inks are usually radiation curable or solvent-based inks. In the present invention, we take the technology to a water-based digital ink platform and combine this with state-of-the-art polymer technology to lock the polymeric colorant in a cured film after printing, which is resistant to migration. This is especially important for applications such as indirect food contact packaging, printing onto pharmaceutical foils, and also non-woven but porous substrates such as food packaging cartons with cardboard or fiberboard as the substrate. Surprisingly, the inks showed good wetting and excellent adhesion to a number of different substrates which are theoretically difficult for aqueous (water-based) inkjet inks.

The inventive inks also help to address a serious issue which is increasing for digital textile decoration, namely sustainability. In most cases, where a reactive dye, acid dye, basic dye or direct dye is used to print onto a textile fabric, the steaming and washing phase tend to release about 30% of the printed ink into the wastewater stream as the dyes in the inks do not have a high level of chemical fixation to the fibrous substrates. Using the inks developed in this invention, the colorant is covalently bound to the polymer, which itself contains free —OH (hydroxyl), thiol (—SH) or primary or secondary amino (—NH₂ or —NHR) groups, preferably free —OH groups. This can form other covalent bonds with acid functional or other functional polymers contained in the ink, and the other functional polymers themselves can also form identical covalent bonds to the free —OH (hydroxyl) groups which are contained in the fibrous fabrics. This results in ˜100% of the ink colorant being bound to the surface and leading to very little discharge into wastewaters, which require significant waste treatment to reduce the levels of biochemical oxygen demand (BOD) and chemical oxygen demand (COD).

In addition, the polymeric colorants themselves can be made using content from renewable (i.e. sustainable) sources and also can be designed and synthesized to have a high degree of biodegradation. Dyestuff printed in the normal manner onto fabrics is causing a major ecological issue as the fabrics are disposed of in landfill and the soil toxicity is large as the dyes take many years to degrade. By incorporating the dyes into biodegradable polymer chains, the colorants in the textiles can degrade much faster in the soil.

Furthermore, classical reactive dyes are typically steamed using high temperature steam to enable fixation of the dyes to the fabrics. This is energy-demanding, time-consuming and relatively inefficient as it slows down the line speed of the process. In the present invention, it was found that simple dry heat can be used to fix the inks onto the fabrics without any discoloration of the colorants. In prior cases where dry heat has been used to fix normal reactive dyes to substrates, the dyes can be heat sensitive and prone to losing color saturation.

Surprisingly, only very small quantities of the polymeric colorant are required in an ink to impart the color, stability, jetting and physical properties of the films when cured. Indeed, only 5-10% w/w of polymeric colorant in the ink was found to give acceptable properties. This is surprising given the high degree of fixation which the printed and cured films displayed.

The inventive inks exhibit good resolubility, good film forming properties despite no cross-linker or further polymer type (i.e. in addition to the polymeric colorant and the acid functional polymer) being required in the ink.

There are many current challenges with the future generations of water-based inks for printing onto non-porous (and also porous) substrates. The challenges are both physical, chemical and physico-chemical. From the perspective of the printing press and printer maintenance, the inks must give excellent jetting performance from the print heads, long open times (in the event the printing heads are not capped appropriately) which have a quick start-up, good resolubility in the case that inks are left to dry out in the machine and the machine can be flushed and recovered, not settle during operation of the printer when ink re-circulating systems are being used. In terms of the ink and the substrate interactions, the inks must bind well to the substrates, without preferably the need for chemical pre-treatments or chemical primers. In the main, it is common practice in the inkjet industry for most substrates to be “de-greased” prior to printing using a corona treatment on-line or off-line. The color of the inks must be vibrant, and the inks when bind to the surface must be able to withstand a multitude of physical tests such as adhesion, scratch resistance, alcohol rub resistance, water resistance and crinkling/warping tests. Furthermore, the inks should be capable of printing on the top of base color coats, have top color coats printed on top of them and be able to withstand various lamination processes.

In addition, the inventive inks can preferably be printed digitally, or by other means (e.g. litho, flexo, gravure, screen, etc.) onto rigid and flexible substrates, including textiles, which have not been chemically or physically pre-treated. The pre-treatment of fibrous fabrics such as cotton with chemical agents to enable the surface groups to be more receptive to the reactive dyes is well documented and standard practice. It was found that the inks according to the present invention can be directly printed onto untreated, non-primed fabrics with excellent adhesion. Accordingly, the inventive inks do not require a chemical primer layer or chemical pre-treatment on the substrate. However, where a chemical primer layer or chemical pre-treatment are optionally used, then the inks demonstrate equally good printing performance.

To this end, the inventors have developed the use of a polymeric colorant to generate a series of inks which solve the problems mentioned above.

The present invention provides a printing ink composition comprising one or more solution soluble polymeric colorant(s), one or more acid functional polymer(s), water and one or more organic co-solvent(s), wherein the polymeric colorant(s) comprises polymer chains having at least one hydroxyl (—OH), thiol (—SH) or primary or secondary amino (—NH₂ or —NHR) group on the polymer chain; wherein the ink is suitable for inkjet deposition.

As will be understood in the art, the hydroxyl (—OH), thiol (—SH) or primary or secondary amino (—NH₂ or —NHR) groups on the polymer chain are free, non-bound groups when they are on the polymer chain, i.e. they are available to form a covalent bond or other interaction, for instance with acid functional or other functional polymers contained in the ink, or to bond to functional groups on the surface of the substrate, for example, cellulosic —OH groups, fixing the ink to the surface.

As is understood in the art, the term “solution soluble” polymer (also known as an alkali-soluble polymer or a solution-polymer) typically refers to polymers that comprise acidic functionality as part of the monomer blend that are capable of being neutralized with a base such that the polymers can then be dissolved in water to form an aqueous solution or to polymers that comprise hydrophilic groups on the polymer backbone or polymer side-chains that can render the polymers soluble in water to form an aqueous solution. Suitable hydrophilic groups include hydroxyl-functional groups, thiol-functional groups, amino-functional groups or polyether repeating units such as polyethylene glycol or polypropylene glycol.

In the solution soluble polymers of the present invention, the water solubility may be achieved by the presence of said at least one hydroxyl (—OH), thiol (—SH) or primary or secondary amino (—NH₂ or —NHR) group on the polymer chain. Said solution soluble polymers may further comprise polymer side-chains, such as the afore-mentioned hydrophilic repeating units such as polyethers (preferably polyethylene glycol or polypropylene glycol) to increase solubility in water.

In a preferred aspect of the present invention, the solution soluble polymeric colorant comprises acidic groups (particularly sulfonic acid groups) which are capable of being neutralized with a base such that the polymeric colorant is converted to salt from that can be dissolved in water to form an aqueous solution. In a particularly preferred aspect, the solution soluble polymeric colorants comprise polyalkylene glycol (preferably PEG or PPG) repeating units intermittently linked to reactive or acid dyes, wherein said reactive or acid dyes comprise sulfonic acid groups which are capable of being neutralized with a base such that the polymeric colorant is converted to salt from that can be dissolved in water to form an aqueous solution.

The present invention also provides a water-based polymeric colorant (preferably a polymeric dye) ink set comprising at least a polymeric colorant (preferably a polymeric dye) containing —OH functional groups, —NH₂ functional groups, —NHR functional groups or —SH functional groups, an acid functional polymer, water, an organic solvent and optionally an additional surfactant, biocide, wetting agent and other low levels of specialty chemical additives. The acid functional polymer can function as a binder and preferably no additional binder (i.e. other than the acid functional polymer) is present in the ink formulations.

The present invention also provides a method for the decoration of a substrate or film, typically a textile material (e.g. a fibrous textile fabric), by contacting a substrate with a water-based ink according to the invention and subsequently fixing said water-based ink onto said substrate, by NIR radiation for example. Alternatively, the present invention also provides a method for the decoration of textiles, paper, leather, wood, wall covering materials (e.g. wallpaper), cardboard, fibreboard and even metal or plastic, by contacting a substrate with a water-based ink according to the invention and subsequently fixing the said water-based ink onto said substrate using heat curing. Although in a preferred aspect the substrates do not contain a chemical primer or chemical pre-treatment layer, it will be understood that in an alternative aspect the substrates can be optionally pre-treated with a coating which contains a material having free carboxylic acid groups, or other groups which are capable of reacting with the —OH (or —NH or —SH) groups on the polymeric colorant.

The present invention also provides a water-based polymeric colorant (preferably a polymeric dye) ink set comprising at least a polymeric colorant containing —OH functional groups, water, an organic solvent, a polymer having at least some carboxylic acid or other acid functionality, and optionally an additional surfactant, biocide, wetting agent and other low levels of specialty chemical additives.

The present invention also provides a water-based polymeric colorant (preferably a polymeric dye) ink set comprising at least a polymeric colorant containing —OH functional groups, water, an organic solvent, a polymer having at least some carboxylic acid or other acidic functionality, a carbodiimide (CDI) crosslinking agent, and optionally an additional surfactant, biocide, wetting agent and other low levels of specialty chemical additives.

The present invention also provides a method for preparing a water-based ink according to the invention, comprising adding water, an organic solvent and optionally additional other chemical agents to the polymeric dyes and acid functional polymer, thereby obtaining water-based inks.

The present invention also provides a method for printing a variety of different substrates, comprising the steps of:
i. Applying a water-based ink according to the invention onto the substrate; and
ii. Fixation of said water-based ink onto said substrate using air drying, forced convection, IR or NIR-radiation or thermal curing.

The present invention also provides a decorated substrate which is formed from the deposition of an ink incorporating a polymeric dye, whereby said substrate can be printed with at least one or more inks and cured by either a serial arrangement of IR or NIR lamps, or air dried, or forced air dried or thermally cured using a thermal heating device.

The present invention also provides a series of aqueous polymeric dye inks for use in printing onto rigid and flexible substrates enabling high line speed digital decoration of said substrates with superior print quality.

The present invention also provides a method for the decoration of rigid and flexible substrates which do not require a pre-treatment or primer layer enabling faster production times and less environmental pollution from chemical pre-treatment agents such as urea and sodium alginate.

The present invention also provides a method for the decoration of rigid and flexible substrates which can be fixed using dry heat. This also enables faster line speeds and greatly reduces the energy consumption required for traditional steaming processes.

Ink Additives

Polymeric Colorants

As will be understood in the art, a polymeric colorant is a dye, an organic pigment, an inorganic pigment or lake pigment of a dye covalently linked to a polymer. As used herein, a lake pigment of a dye is an organic pigment that has been made by precipitating a water-soluble dye with an inert binder such as a metallic salt. Preferably, the polymeric colorant according to the present invention is a polymeric dye, i.e. a dye covalently linked to a polymer.

The polymeric dyes used in the present invention are co-polymers or block co-polymers having hydrophilic and hydrophobic functionality incorporated within it. The polymeric dyes contain free hydroxyl (—OH), thiol (—SH), primary amino (—NH₂) or secondary amino (—NHR) groups on the polymer, wherein “R” is an alkyl, aryl or heteroaryl group, preferably an alkyl or aryl group.

As used herein, an alkyl group is a saturated or unsaturated straight chain, branched or cyclic hydrocarbon having from 1 to 16 carbon atoms, preferably from 1 to 8 carbon atoms, more preferably from 1 to 6 carbon atoms. Preferably, the alkyl group is a saturated non-cyclic alkyl group (i.e. a straight chain or branched alkyl group).

Representative saturated non-cyclic alkyl groups include methyl, ethyl, n-propyl, isopropyl, n-butyl, sec-butyl, isobutyl, tert-butyl, n-pentyl, iso-pentyl, neopentyl, tert-pentyl, n-hexyl, 2-methylpentyl, 3-methylpentyl, 4-methylpentyl, 2,3-dimethylpentyl groups and the like. Representative cyclic alkyl groups include cyclopropyl, cyclobutyl, cyclopentyl, cyclohexyl, cycloheptyl and the like. As used herein, alkyl groups can be substituted or unsubstituted.

As used herein, an aryl group is an aromatic carbocyclic group of from 6 to 14 carbon atoms having a single ring (e.g. phenyl) or multiple condensed rings (e.g. naphthyl). Preferably, the aryl group has 6 to 12 carbon atoms, more preferably 6 to 10 carbon atoms. Representative aryl groups include phenyl, biphenyl, naphthyl and the like. The aryl groups can be substituted or unsubstituted.

As used herein, a heteroaryl group is an aromatic ring system having one to four heteroatoms as ring atoms in a heteroaromatic ring system, wherein the remainder of the atoms are carbon atoms. Preferably, the heteroaryl group has 3 to 12 ring atoms, more preferably 3 to 6 ring atoms. Suitable heteroatoms include oxygen, sulfur and nitrogen. The heteroaryl group can be substituted or unsubstituted.

The polymeric dyes class is preferably water-soluble polyethylene glycol (PEG), polypropylene glycol (PPG), and other alkyl alkoxylate ether polymers containing a dye affixed covalently to the polymer.

Preferably, the polymeric dyes used in the present invention have one or more hydroxyl groups. Preferably, the polymeric dyes used in the present invention have a hydroxyl value of 50-300 mg KOH/g, more preferably 80-200 mg KOH/g.

Preferably, the polymeric dyes used in the present invention have one or more primary or secondary amino groups. Preferably, the polymeric dyes used in the present invention have an amine value of 30-280 mg KOH/g, more preferably 70-200 mg KOH/g.

Preferably, the polymeric dyes used in the present invention have one or more thiol (i.e. SH) group(s), more preferably the polymeric dyes used in the present invention have at least two thiol (i.e. SH) groups.

Examples of suitable polymeric dyes include but are not limited to Evertint Yellow R-01, Evertint Orange R-01, Evertint Red R-01, Evertint Violet R-01, Evertint Blue R-01, Evertint Black R-01, from Everlight Chemical Industrial Corporation; Reactint Black X77, Reactint Yellow X15, Reactint Orange X96, Reactint Red X64, Reactint Violet X80LT, Reactint Blue X3LV from Milliken Corporation.

Preferably, the amount (by weight) of the polymeric colorant in the inkjet ink compositions is at least 0.1%, such as at least 0.5%, at least 1%, at least 1.5%, at least 2%, at least 3%, at least 4%, at least 5% by weight. Preferably, the amount of the polymeric colorant is at most 15%, such as at most 12%, at most 10%, at most 8%, at most 7%, at most 6%, and at most 5% by weight. Accordingly, the amount of the polymeric colorant in the compositions is preferably 0.1 to 15% by weight, more preferably 1 to 12% by weight, most preferably 3 to 10% by weight.

A polymeric colorant used in the inventive inkjet ink compositions can comprise one or more embodiments described herein.

Acid Functional Polymers

The ink composition according to the present invention includes one or more acid functional polymer(s) in addition to the polymeric colorant. Preferably, the one or more acid functional polymer(s) is selected from the group consisting of styrene/acrylic acid copolymers, styrene/maleic acid copolymers, styrene/maleamic acid copolymers, styrene/maleic acid/alkyl acrylate copolymers, styrene/methacrylic acid copolymers, styrene/methacrylic acid/alkyl acrylate copolymers, styrene/maleic half ester copolymers, vinyl naphthalene/acrylic acid copolymers, vinyl naphthalene/maleic acid copolymers, polyacrylics, salts thereof and blends thereof.

Preferably, the acid functional polymer is a styrene/maleic acid copolymer (i.e. a poly(styrene-maleic acid) copolymer), a styrene/maleamic acid copolymer (i.e. a poly(styrene-maleamic acid) copolymer) or a combination thereof. Preferably, the acid-functional polymer is a poly(styrene-maleamic acid) copolymer.

As will be understood in the art, poly(styrene-maleic acid) copolymers comprise styrenic and maleic acid repeating units. Similarly, poly(styrene-maleamic acid) copolymers comprise styrenic and maleamic acid repeating units. As will be further understood in the art, the acidic groups in maleic acid and maleamic acid can form salts with an appropriate neutralizing agent.

Preferably, the maleic acid or maleamic acid repeating unit in the copolymer is a mono-sodium salt, a di-sodium salt, a mono-ammonium salt, a di-ammonium salt, a mono-quaternary ammonium salt or a di-quaternary ammonium salt.

Preferably, the poly(styrene-maleic acid) copolymer or poly(styrene-maleamic acid) copolymer is selected from a di-sodium salt of poly(styrene-maleic acid) copolymer, a di-ammonium salt of poly(styrene-maleic acid) copolymer, a mono-ammonium salt of poly(styrene-maleamic acid) copolymer, a mono-quaternary ammonium salt of poly(styrene-maleamic acid) copolymer or combinations thereof.

Examples of suitable poly(styrene-maleic acid) copolymers and poly(styrene-maleamic acid) copolymers include, but are not limited to, poly(styrene-alt-maleic acid) sodium salt solution from Merck; SMA 1000 H, SMA 1000HNa, SMA 2000H, SMA 2000HNa, SMA 3000H, SMA 3000HNa, SMA 1000 AMP, SMA 2000 AMP and SMA 3000 AMP from Polyscope Polymers. Further examples of suitable poly(styrene-maleic acid) copolymers and poly(styrene-maleamic acid) copolymers include Xiran 3000 HNa, Xiran 1000A, Xiran 2000A, Xiran 1550H and Xiran 3000H from Polyscope Polymers.

Preferably, the acid functional polymer has an acid number of ≥225 mg KOH/g, more preferably ≥300 mg KOH/g. Preferably, the acid number of the acid functional polymer is 225-550 mg KOH/g, preferably 255-550 mg KOH/g.

Preferably, the acid functional polymers have a molecular weight of ≥3,000 Daltons, preferable ≥3,500 Daltons. Preferably, the acid functional polymers have a molecular weight of 3,000-20,000 Daltons, preferably 3,500-15,000 Daltons.

Preferably, the acid functional polymer is present in an amount of from about 0.1 to about 15 wt % of the composition, preferably from about 0.5 to about 12 wt % of the composition, more preferably from about 1 to about 8 wt % of the composition.

Preferably, the acid functional polymer is a poly(styrene-maleic acid) copolymer, a poly(styrene-maleamic acid) copolymer or a combination thereof and the acid functional polymer is present in an amount of from about 0.1 to about 15 wt % of the composition, preferably from about 0.5 to about 12 wt % of the composition, more preferably from about 1 to about 8 wt % of the composition.

Optional Additives

The ink compositions may be, but are not limited to, inkjet ink compositions that can optionally include one or more additives that are compatible with the other components of the composition. Additives can be included in the composition to impart any number of desired properties, including, but not limited to, stability, smear resistance, viscosity, surface tension, coating penetration, optical density, color depth, adhesion, highlighter resistance, resolubility and crust resistance, among others. Suitable additives for such uses and the amounts of such additives used are known and conventionally used in the art.

Examples of optional additives include, but are not limited to, defoamers, preservatives, surfactants, wetting agents, pH modifiers, viscosity modifiers, humectants, penetrating agents, and additional polymers (i.e. polymers in addition to the polymeric colorant and the acid functional polymer), among others.

Preferably, defoamers can be included in the ink composition, to inhibit the formation of foam. Examples of suitable defoamers include, but are not limited to, silicone-based or non-silicone defoamers. Commercially available defoamers include, but are not limited to, Dow Corning® 71 and Dow Corning® 74 (from Dow Corning), TegoAirex® 901W, 902W, 904W from Evonik Industries/Tega, Tergitol® L-61, L-62, L-64 and L-101 (from Dow Chemical). A typical amount (by weight) of defoamer included in the composition is 0.1 to 3% by weight.

Preferably, preservatives, such as biocides and fungicides, can be included in the ink composition to inhibit the growth of microorganisms. Examples of suitable preservatives include, but are not limited to, sodium benzoate, pentachlorophenol sodium, 2-pyridinethiol-1-oxide sodium, sodium sorbate, sodium dehydroacetate, benzisothiazolinone, 1,2-dibenzothiazolin-3-one, 1-(3-chlorallyl)-3,5,7-triaza-1 azoniaadamantane chloride (CTAC), methylisothiazolinone, and chloromethylisothiazolinone, among others. Commercially available biocides include UCARCIDE® 250 (available from Union Carbide Company), Proxel® CRL, Proxel® BDN, Proxel® GXL, Proxel® XL-2, Proxel® TN (available from Arch Chemicals, Smyrna, Ga.), Dowicil® (Dow Chemical, Midland, Mich.), Nuosept® (Huls America, Inc., Piscataway, N.J.), Omidines® (Olin Corp., Cheshire, Conn.), Nopcocides® (Henkel Corp., Ambler, Pa.), Troysans® (Troy Chemical Corp., Newark, N.J.), and XBINX® (PMC Specialties Group, Inc., Cincinnati, Ohio). The preservatives may be used alone or in combination. A typical amount (by weight) of preservative included in the composition is 0.1 to 1.5% by weight.

Preferably, the ink compositions according to the present invention can include a surfactant and/or a wetting agent. Suitable wetting agents include polyether siloxane co-polymers such as Tego Wet KL 245 (Evonik). Preferably, the wetting agent is present in the composition in 0.1 to 2% by weight. As will be understood in the art, wetting agents lower the interfacial tension of water allowing it to spread on a solid surface.

Preferably, surfactants can be included to reduce surface tension of the ink composition. The surfactant can be an anionic surfactant, non-ionic surfactant or cationic surfactant. Suitable surfactants can include, but are not limited to, those listed below and in U.S. Pat. Nos. 5,116,409, 5,861,447 and 6,849,111. Exemplary surfactants are commercially available under various trade names, such as the PLURONIC® series (BASF Corporation, Parsippany, N.J.), TETRONIC® series (BASF Corporation, Parsippany, N.J.), ARQUAD® series (Akzo Chemical Inc., Chicago, Ill.), TRITON® series (Union Carbide Corp., Danbury, Conn.), SURFONIC® series (Texaco Chemical Company, Houston, Tex.), ETHOQUAD® series (Akzo Chemical Inc., Chicago, Ill.), ARMEEN® series (Akzo Chemical Inc., Chicago, Ill.), ICONOL® series (BASF Corporation, Parsippany, N.J.), SURFYNOL® series (Air Products and Chemicals, Inc. Allentown, Pa.), and ETHOMEEN® series (Akzo Chemical Inc., Chicago, Ill.), among others. The surfactants can be used alone or in combination. A typical amount (by weight) of surfactant included in the composition is 0.1 to 10% by weight.

Preferably, pH modifiers can be included to adjust or buffer the ink composition to a desired pH. Suitable pH modifiers include, but are not limited to, alkali hydroxides, alkali carbonates and bicarbonates, triethylamine, dimethylethanolamine, triethanolamine, aminomethyl propanol (AMP), mineral acids, hydrochloric acid, and sulfuric acid, among others. The pH modifiers can be used alone or in combination. A typical amount (by weight) of pH modifier in the composition is 0.1 to 2% by weight.

Preferably, the ink composition can include one or more viscosity modifiers. Examples of suitable viscosity modifiers include, but are not limited to resin compounds, alginic acid compounds, polyvinyl alcohol, hydroxypropyl cellulose, carboxymethyl cellulose, hydroxyethyl cellulose, methyl cellulose, salts of polyacrylic acid, polyvinyl pyrrolidone, gum arabic and starch, hydrophobic ethoxylated urethanes (HEURs), hydrophobically modified alkali swellable emulsions (HASEs), alkali swellable emulsions (ASEs), among others. The viscosity modifiers can be used alone or in combination. A typical amount (by weight) of viscosity modifier in the composition is 0.5 to 10% by weight.

Preferably, in addition to an organic co-solvent of the fluid carrier component which can function as a humectant, one or more additional humectants can be included in the inkjet ink composition if required to reduce the rate of evaporation of the water component and prevent an ink composition from drying out in the nozzles of the printhead, which can occur during periods of latency, to minimize clogging of the nozzles. Humectants can be selected from materials having high hygroscopicity and water-solubility. Examples of suitable humectants include, but are not limited to, polyols (e.g., glycerol, ethylene glycol, propylene glycol), alcohol ethers (e.g., diethylene glycol, triethylene glycol, dipropylene glycol), lactams (e.g., 2-pyrrolidone, urea compounds such as urea, 1,3-dimethylimidazolidinone), saccharides (e.g., sorbitol), 1,4-cyclohexanedimethanol, 1-methyl-2-piperidone, N-ethylacetamide, 3-amino-1,2-propanediol, ethylene carbonate; butyrolacetone and Liponic EG-1, among others. There are no particular limitations on the amount used of the humectant. A typical amount (by weight) of humectant in the composition is 0.5 to 30% by weight.

Preferably, penetrating agents can be included to reduce bleeding of an ink composition when applied to a print substrate such as paper, among others. Examples of suitable penetrating agents include, but are not limited to, alkyl alcohols having 1 to 4 carbon atoms (e.g., ethanol), glycol ethers (e.g., ethylene glycol monomethyl ether), diols (e.g., 1,2-alkyl diols), formamide, acetamide, dimethylsulfoxide, sorbitol and sulfolane, among others. The penetrating agents may be used alone or in combination. A typical amount (by weight) of penetrating agents in the composition is 1 to 20% by weight.

Preferably, the ink composition can optionally include additional polymers (other than the polymeric dyes and acid functional polymers) to enhance waterfastness, rub and lightfastness of an ink image applied to and dried on a print substrate. Examples of such polymers include, but are not limited to, polyvinyl alcohols, polyesters, polyestermelamines, styrene/acrylic acid copolymers, styrene/maleic acid/alkyl acrylate copolymers, styrene/methacrylic acid copolymers, styrene/methacrylic acid/alkyl acrylate copolymers, styrene/maleic half ester copolymers, vinyl naphthalene/acrylic acid copolymers, vinyl naphthalene/maleic acid copolymers, polyacrylics, polyurethanes, hydroxyl functional polymers and salts thereof, among others. Where an optional, additional polymer is included in the ink composition it can preferably be a polyacrylic or polyurethane (including a hydroxyl functional polyurethane). In addition, examples of other polymers capable of undergoing a cross linking reaction with the polymeric dye may also optionally be included and these include, but are not limited to, poly(ethyleneketone) and poly(propyleneketone).

Such additional polymers can be used alone or in combination. A typical amount (by weight) of such additional polymers that can be included in the composition is 0.1 to 20% by weight.

Preferably, the ink composition can optionally include a self-crosslinking polymer to improve the durability of an ink image applied to and dried on a print substrate. Examples of such self-crosslinking polymers for use in the ink compositions include, but are not limited to, self cross-linking acrylic polymers, styrene-acrylic copolymers, styrene-butadiene latexes, styrene-isoprene latexes, acrylonitrile-butadiene latexes, alkyd dispersions, vinyl polymers, silicone dispersions, polyamide dispersions, chlorinated olefin dispersions, and polyester dispersions, among other self-crosslinking polymers. Such self-crosslinking polymers can be used alone or in combination. A typical amount (by weight) of such self-crosslinking polymers that can be included in the composition is 0.1 to 20% by weight.

Preferably, the ink compositions can optionally include a chemical cross-linker. Examples of such cross-linking agents include, but are not limited to Picassian XL-701, Picassian XL-702, Picassian XL-725, Picassian XL-732, Picassian XL-752, Picassian XL-755, Picassian XL-762 from Stahl; Carbodilite V-02, Carbodilite V-02-L2, Carbodilite SV-02, Carbodilite V-04, Carbodilite V-10, Carbodilite E-02, Carbodilite E-05 from Nisshinbo Chemicals; Zoldine XL-29SE from Angus Chemicals.

Preferably, the ink compositions can include a catalyst which is capable of lowering the activation energy or temperature to enable chemical cross-linking to occur. Examples of such additives are various kaolins, colloidal silicas, etc.

Other additives that can be included in the ink compositions include, but are not limited to, antioxidants, ultraviolet absorbers, chelating agents, electric conductivity adjusters, oxygen absorbers, anti-kogation agents, anti-curling agents, and fragrances, among others. The amounts of such additives for use in aqueous inkjet ink compositions are known and conventionally used in the art.

Fluid Carrier

The inkjet ink compositions comprise a fluid carrier which comprises water and one or more organic co-solvents, which can be water-soluble organic co-solvents, water-miscible organic co-solvents, or a combination thereof. The organic co-solvents can be added either alone or in combination.

Preferably, the organic co-solvents are humectants, which can reduce the rate of evaporation of the water component and prevent an ink composition from drying out or crusting in the nozzles of the printhead to minimize clogging of the nozzles. In some embodiments, the organic co-solvents can enhance solubility of the components in the inkjet ink composition and facilitate penetration of a printed ink composition into a substrate.

Suitable water-soluble and water-miscible organic solvents include, but are not limited to, alcohols (e.g., methanol, ethanol, propanol, isopropyl alcohol, butanol, polyols, ethylene glycol, propylene glycol, dipropylene glycol, glycerine, and polyethylene glycol (PEG), among others), ketones and ketone alcohols (e.g., acetone and diacetone alcohol, among others), ethers (e.g., tetrahydrofuran, dioxane, and alkylethers, among others), ethers of polyhydric alcohols (e.g., ethylene glycol monomethyl ether, ethylene glycol monoethyl ether, ethylene glycol monoethyl ether acetate, di(ethyleneglycol) monomethyl ether), nitrogen-containing solvents (e.g., 2-pyrrolidone, and N-methyl2-pyrrolidone, among others), sulfur-containing solvents (e.g., 2,2′-thiodiethanol, dimethylsulfoxide, tetramethylene sulfone, and sulfolane, among others), and sugars and derivatives thereof (e.g., glucose, oxyethylene adducts of glycerin, and oxyethylene adducts of diglycerin, among others). Preferably, the organic co-solvent is propylene glycol, dipropylene glycol or a combination thereof.

Preferably, the amount (by weight) of the organic co-solvent in the inkjet ink composition is at least 1, such as at least 5, and at least 10% by weight. Preferably, the amount (by weight) of the organic co-solvent is at most 60, such as at most 50, at most 40, and at most 30% by weight. This includes embodiments in which the amount of the organic co-solvent in the composition is 1 to 80% by weight, such as 10 to 50% by weight. Preferably, the amount of the organic co-solvent in the ink is 5 to 35% by weight.

An organic co-solvent used in the inventive ink compositions can comprise one or more embodiments described herein.

Preferably, the inks according to the present invention are water-based. Unless stated otherwise, water-based inks comprise at least 20, at least 25, and at least 30% by weight. Preferably, the amount (by weight) of water is at most 95, at most 85, at most 80, at most 75, at most 70, at most 65, and at most 60% by weight. Accordingly, the amount of water in the composition is 20 to 95% by weight, such as 20 to 80, and 20 to 70% by weight. Preferably, the range of water in the composition is 30 to 75% by weight, and more preferably 30 to 60% by weight.

Preparation of the Inkjet Ink Compositions

The invention also provides methods of preparing the inkjet ink compositions disclosed herein. In some embodiments, the inkjet ink compositions of the invention can be prepared by mixing a polymeric colorant (preferably a polymeric dye) and an acid functional polymer in water with at least an organic solvent, a wetting agent, and optionally further quantities of a biocide.

In some embodiments, the inkjet ink composition can also be prepared by mixing a polymeric colorant (preferably a polymeric dye) and an acid functional polymer in water with at least an organic solvent, a wetting agent, and optionally further quantities of a cross-linking agent, optionally further fluid carrier, a biocide and other optional additives.

In some embodiments, the fluid carrier can be prepared by combining one or more water-soluble organic co-solvents, one or more water-miscible organic co-solvents or a mixture thereof, with water, which can be combined with the other components of the composition. In embodiments, the organic co-solvent(s) and water of the fluid carrier can be combined directly with the polymeric colorant(s), acid functional polymer(s), optional crosslinking agent and optional additives.

An ink composition according to the invention can comprise a combination of two or more embodiments described herein.

The water-based inks are prepared in the normal manner. The polymeric colorant can be obtained from several different sources. To the stirred liquid comprising water, is added the organic co-solvent(s), or vice versa. The polymeric colorant(s), which is typically a liquid, is then added slowly, and the other components of the ink are then added—this may be components such as biocides or preservatives, binders, polymers, resins, surfactants, wetting agents and small quantities of other co-solvents. The ink is pumped under positive pressure through a cartridge filter and packed.

Methods of Printing

The invention further includes methods of printing an image on a substrate by applying an inkjet ink composition according to the invention onto the substrate. In some embodiments, the inkjet ink compositions disclosed herein are adapted for use with an inkjet printing apparatus.

In an embodiment of a method of printing an image, droplets of an inkjet ink composition as disclosed herein are ejected from a small nozzle of a printhead and deposited onto a print substrate to generate an image thereon. Suitable inkjet ink printing apparatus can include, but are not limited to, Drop-on-Demand Valve (DoD Valve), MEMS technology and Drop-on-Demand PiezoElectric (DoD Piezo).

Examples of suitable print substrates to which this invention is particularly directed include, but are not limited to, transparency materials (e.g. cellulose acetate films such as those commonly used as packing films), textile materials, leather, metals, ceramics, glass, plastics, polymeric films and woods, among others.

Preferably, the substrates that are suitable for use in the present invention are fibrous. As used herein, a fibrous substrate is a material that is composed from fibres, which may be natural fibres or synthetic fibres. Preferably, the fibrous substrates that are suitable for use in the present invention are made from natural fibres such as cellulose or protein (e.g. collagen) fibres. Preferably, the fibrous substrate is composed from natural fibres and is selected from wood (e.g. fiberboard), paper (e.g. wallpaper or cardboard), leather, silk, cotton, wool (e.g. merino wool or cashmere), hemp, ramie, sisal, bamboo, flax or blends of the same.

As will be appreciated in the art, wood, cotton, hemp, ramie, sisal, bamboo and flax comprise cellulose fibres and can therefore be referred to as cellulosic substrates. However, the present invention is not limited to natural cellulosic substrates and also includes synthetic cellulosic substrates such as rayon. As used herein rayon substrates include viscose rayon, modal rayon acetate rayon and lyocell rayon as well as cellulose acetate.

As will be understood in the art, the term “fibrous” used in connection with cellulosic substrates does not refer to polymeric cellulosic chains, but instead to the fibres formed by multiple polymeric cellulosic chains which are bound together by intermolecular forces between chains to form cellulose fibres comprising many tens of polymer chains as, for instance, found in naturally occurring cellulosic fibre such as cotton.

Preferably, the fibrous substrate is a textile. As will be understood in the art, textiles are formed from weaving, knitting, crocheting, knotting, tatting, felting, bonding and/or braiding yarns, which themselves are formed from fibres. The textile substrates suitable for use in the present invention may be formed from or are any one or more of the fibres described herein. According, the textile substrate can preferably be formed from or is cotton, rayon, silk, polyester, PET, spandex, nylon, leather, wool, hemp, ramie, sisal, bamboo, flax, MET-OPP (Metalized Orientated Polypropylene), MET-PET (Metallized Polyethylene Terephthalate), PP (polypropylene), PVC (Polyvinyl Chloride) or blends thereof (such as a polyester-blend). Preferably the textile substrate is canvas, chenille, chiffon, crepe, damask, georgette, gingham, jersey, lace, linen, polyvinyl chloride, leather, merino wool, modal, muslin, organza, satin, spandex, suede, taffeta, toile, tweed, twill and velvet.

Alternatively, the substrates that are suitable for use in the present invention are preferably metals, ceramics, glass, plastics or polymeric films. Exemplary metals include steel and copper, which may or may not be coated, e.g. with a white primer layer and/or a clearcoat covering. Exemplary polymeric films include non-fibrous cellulosic substrates such as cellophane, cellulose acetate, cellulose acetate butyrate, cellulose acetate propionate, cellulose nitrate and cellulose propionate.

Preferably, the substrate used in the present invention does not contain a chemical primer or chemical pre-treatment layer on its surface, and so the ink is printed directly onto the substrate. As will be understood in the art, a chemical primer layer is an intermediary layer between the substrate and the ink that facilitates adhesion between the substrate and the ink. Similarly, it will be understood in the art that chemical pre-treatment of a substrate involves applying a chemical substance to the substrate before printing which binds to the substrate and which facilitates adhesion between the substrate and the ink.

As will be understood in the art, a chemical primer or chemical pre-treatment is distinct from a physical pre-treatment of the substrate. Accordingly, the substrate suitable for use in the present invention may be subjected to a physical pre-treatment prior to being printed, for example a plasma pre-treatment. As will also be understood in the art, a chemical primer or chemical pre-treatment for adhesion promotion is distinct from a passivating protective layer on the substrate, for instance for the purpose of corrosion resistance. Accordingly, the substrate may comprise a passivating protective layer, for instance as is present in protected steel. As is understood in the art, metal substrates are typically protected to prevent corrosion and protection may involve galvanizing the metal (e.g. steel) with a layer of a zinc before printing on the substrate.

The inkjet ink compositions according to the present invention are formulated to have properties that allow for at least one of the following: 1) uniform, bleed-free print images with high resolution and high density on a print substrate; 2) inhibition or prevention of nozzle clogging which typically occurs due to drying of the ink at a distal end of a nozzle of the printing apparatus; 3) rapid drying on a print substrate (paper, fabric, film, etc.); 4) long-term storage stability; and 5) print characteristics that are independent of the print substrate quality. The inkjet ink compositions can also provide ink stability and robustness against fluctuating temperature conditions which can occur during transport and storage, to eliminate or inhibit nozzle clogging, banding, and poor print quality.

The inkjet ink compositions disclosed herein can be adapted specifically for use in textile, leather, paper, wood and metal printing processes. Preferably, the inkjet ink compositions adapted for textile printing can be formulated to have at least one of the following properties: 1) fastness to textile fabrics such as cotton, wool, hemp, linen, ramie, sisal, rayon, cellulose acetate, bamboo, flax, or blends of the same; and 2) ease of application and fixation to the fibrous substrate.

The ink is then suitable for use in an industrial high-speed digital printing press for the decoration of textiles and other fibrous materials (for example, wood). On printing the films, with the combination of the black ink and standard inks of other colours comprising, for example at least Cyan, Magenta and Yellow, and may also include, but not limited to spot colours such as Red, Orange, Violet and Green, the sequence of printing by digital means the separate colours and drying the resulting deposited wet inks by Near Infra-Red lamps at full power, enables the printing press to run at full speed and results in no deformation of the printed films. The end result is a very high productivity and a very high final print quality.

As will be understood in the art, a textile fabric is typically pre-treated with a chemical agent containing free polymeric —COOH groups either in-line or off-line. The ink can then be printed by inkjet means onto the pre-treated substrate using the methods described previously and then the fabric can be either heated, steamed or cured thermally using a radiative method. However, in the present invention the ink already contains a polymer (e.g. a co-polymer) containing an acid functional group, and optionally a cross-linker, therefore the ink can be printed directly onto the fabric (i.e. without any pre-treatment) and either heated, steamed or cured thermally using a radiative method.

In some preferred aspects of the invention, the substrates used are non-porous and the water-based inks can be printed directly onto the non-porous surfaces, for example, glass, plastic, foils, or metal in the same way as the methods described above.

Measurement Methods

Hydroxyl value (OHV): Hydroxyl value (or hydroxyl number) is defined as the number of milligrams of potassium hydroxide required to neutralize the acetic acid taken up on acetylation of one gram of a chemical substance that contains free hydroxyl groups. The hydroxyl value is suitably measured in accordance 5 with the ISO 4629-1:2016(E) standard.

Amine value (AmV): Amine value (or amine number) is defined as the mass equivalent of potassium hydroxide that is required when one gram of substance is neutralized with a suitable acid (typically hydrochloric acid). The amine value is suitably measured in accordance with the DIN 53176:2002-11 standard.

Acid Value (AV): Acid value (or acid number) is defined as the mass of potassium hydroxide (KOH) in milligrams that is required to neutralize one gram of chemical substance. The acid value is suitably measured in accordance with the ISO 2114:2000(E)(method B) standard.

Molecular Weight: The terms “molecular weight” or “average molecular weight” is a reference to the weight average molecular weight (Mw). The molecular weight is suitably measured by techniques known in the art such as gel permeation chromatography. Preferably, molecular weight is measured by comparison with a polystyrene standard. For instance, molecular weight determination may be conducted on a Hewlett-Packard 1050 Series HPLC system equipped with two GPC Ultrastyragel columns, 103 and 104 Å (5 μm mixed, 300 mm×19 mm, Waters Millipore Corporation, Milford, MA, USA) and THF as mobile phase. The skilled person will appreciate that this definition of molecular weight applies to polymeric materials which typically have a molecular weight distribution.

Unless stated otherwise, the viscosities of the inks were measured using a Brookfield DV-II+ Pro Viscometer equipped with an Enhanced Brookfield UL Adapter at 60 rpm and 32° C.

Unless stated otherwise, pH and conductivity were measured at 25° C. using an Oakton 510 series pH/conductivity meter.

Unless stated otherwise, dynamic surface tension is measured using a SITA bubble pressure tensiometer at 25° C. and 2.7 Hz and static surface temperature is measure using a SITA bubble pressure tensiometer at 25° C. and a bubble frequency of 0.025 Hz.

The invention is further described by the following numbered paragraphs:
1. A printing ink comprising one or more solution soluble polymeric colorants, one or more acid functional polymers, water and one or more organic co-solvents; wherein the inks are suitable for inkjet deposition.
2. The ink of paragraph 1, wherein the one or more acid functional polymers are selected from the group consisting of polyvinyl alcohols, polyesters, polyestermelamines, styrene/acrylic acid copolymers, styrene/maleic acid copolymers, styrene/maleic acid/alkyl acrylate copolymers, styrene/methacrylic acid copolymers, styrene/methacrylic acid/alkyl acrylate copolymers, styrene/maleic half ester copolymers, vinyl naphthalene/acrylic acid copolymers, vinyl naphthalene/maleic acid copolymers, polyacrylics, polyurethanes, salts thereof and blends thereof.
3. The ink of any preceding paragraph, further comprising one or more materials selected from the group consisting of surfactants and biocides.
4. The ink of any preceding paragraph, wherein the polymeric colorant contains polymer chains having at least one free non-bound hydroxyl (—OH) group.
5. The inks of any preceding paragraph, wherein the polymeric colorant contains polymer chains having at least one free non-bound amino (—NH₂ or —NHR) group.
6. The inks of any preceding paragraph, wherein the polymeric colorant contains polymer chains having at least one free thiol (—SH) group.
7. The inks of any preceding paragraph, wherein the only polymer incorporated into the ink is the polymeric colorant.
8. The inks of any preceding paragraph, further comprising a functional co-polymer.
9. The inks of paragraph 8, wherein the functionality of the co-polymers is selected from the group consisting of carboxyl (—COOH), hydroxyl (—OH), primary amine (—NH₂), secondary amine (—NHR—), sulfonyl (—SO₃H), phosphonyl (—PO₂H) and blends thereof.
10. The inks of paragraph 6, comprising functional copolymers having counterions selected from the group consisting of lithium, sodium, potassium, ammonium, hydrogen, quaternary ammonium salts of organic amines and blends thereof.
11. The inks of paragraph 10, wherein the quaternary ammonium salts of organic amines are selected from the group consisting of primary, secondary and tertiary aliphatic amines or hydroxyl- or alkoxyl amines and blends thereof.
12. The inks of any preceding paragraph, further comprising a cross-linking agent selected from the group consisting of carbodimide, aziridine, organosilanes and blends thereof.
13. The inks of any preceding paragraph, wherein the polymeric colorant may contain a dye, an organic pigment, an inorganic pigment or the lake pigment of a dye.
14. The inks of any preceding paragraph, comprising a colorant selected from the group consisting of yellow, black, cyan, magenta, orange, red, blue, green, white, violet and blends thereof.
15. The inks of any preceding paragraph, comprising 0.1-15.0 wt % of a polymeric colorant, 2-30 wt % of an organic solvent, ≥0.01 wt % of a surfactant and the remainder of the formulation deionised water.
16. The inks of any preceding paragraph, wherein the pH of the ink is 7.0-10.0, more preferably 7.5-9.5, and even more preferably 7.9-9.7.
17. The inks of any preceding paragraph, wherein the static surface tension is ≤35 dyne/cm, more preferably ≤32 dyne/cm and even more preferably ≤31 dyne/cm.
18. The inks of any preceding paragraph, wherein the dynamic surface tension is ≤33.0 dyne/cm at 0.025 Hz, more preferably ≤32.0 and even more preferably ≤31.
19. A method of printing, comprising depositing the inks of any one or more of paragraphs 1-18 onto a substrate.
20. The method of paragraph 19, wherein the print method is inkjet.
21. The method of paragraph 19 or 20, wherein the substrate is selected from the group consisting of textiles, leather, wood, cardboard, fibreboard, wall papers, steels, copper, coated metals and polyesters.
22. The method of any one or more of paragraphs 19-21 wherein the substrate does not comprise a chemical primer or chemical pre-treatment layer.
23. The method of any one or more of paragraphs 19-22, wherein the substrate is first printed with a base coat of a white or other coloured pigment.
24. The method of any one or more of paragraphs 19-22, wherein the ink is cured by means selected from the group consisting of near infrared (NIR), infrared or airflow.
25. The method of any one or more of paragraphs 20-24, wherein the inkjet printing head is selected from the group consisting of thermal, drop-on-demand, continuous or MEMs.

The present invention has been described in detail, including the preferred embodiments thereof. However, it will be appreciated that those skilled in the art, upon consideration of the present disclosure, may make modifications and/or improvements on this invention that fall within the scope and spirit of the invention.

### EXAMPLES

The invention is further described by the following non-limiting examples which further illustrate the invention, and are not intended, nor should they be interpreted to, limit the scope of the invention.

### Example 1—Cyan/Blue (One Additional Polymer, 5% Polymeric Dye)

To a mechanically stirred tank or vessel using a magnetic stirrer bar is added deionised water, 5.60 g, propylene glycol, 5.20 g, dipropylene glycol, 1.0 g, Xiran 3000H (Polyscope Polymers Inc.; 25% (poly(styrene-maleamic acid) solution in water, acid number 255-305 mg KOH/g and molecular weight 10 kD), 5.0 g and finally Tego Wet KL 245, 0.2 g. 1.0 g (5% w/w) of the blue polymeric colorant, Reactint Blue X3LV or Evertint Blue R-01, was then added, followed by a further addition of deionised water, 2.0 g. The mixture was stirred for a further 1 hour at ambient temperature and then the mixture filtered through a 1-micron absolute glass fiber GF/B Whatman filter paper using vacuum. The physical properties of the ink when using Reactint Blue X3LV as the polymeric dye, were measured to give a viscosity of 4.55 cP (measured at 32° C. at low shear (i.e. at 60 rpm) using a Brookfield DV-II+ Viscometer); pH 8.96 (measured at 25° C. using an Oakton 510 series pH/conductivity meter); conductivity 1.476 mScm⁻¹ (measured at 25° C. using an Oakton 510 series pH/conductivity meter); dynamic surface tension (measured using a SITA bubble pressure tensiometer): 39.2 mNm⁻¹ (measured at 25° C. and 11 Hz), 33.6 mNm⁻¹ (measured at 25° C. and 2.7 Hz), 29.9 mNm⁻¹ (measured at 25° C. and 0.1 Hz) and 29.5 mNm⁻¹ (measured at 25° C. and 0.025 Hz); UV absorbance at lambda max (sample diluted 2,500×) 0.4308 at 630 nm; resolubility measured using an in-house test <1 minute.

### Example 2A—Violet Ink (One Additional Polymer, 5% Polymeric Dye)

To a mechanically stirred tank or vessel using a magnetic stirrer bar is added deionised water, 5.60 g, propylene glycol, 5.20 g, dipropylene glycol, 1.0 g, Xiran 3000H (Polyscope Polymers Inc.; 25% (poly(styrene-maleamic acid) solution in water, acid number 255-305 mg KOH/g and molecular weight 10 kD), 5.0 g and finally Tego Wet KL 245, 0.2 g. 1.0 g (5% w/w) of the violet polymeric colorant, Evertint Violet R-01, was then added, followed by a further addition of deionised water, 2.0 g. The mixture was stirred for a further 1 hour at ambient temperature and then the mixture filtered through a 1-micron absolute glass fiber GF/B Whatman filter paper using vacuum. The physical properties of the ink when using Evertint Violet R-01 as the polymeric dye, were measured to give a viscosity of 5.66 cP (measured at 32° C. at low shear (i.e. at 60 rpm) using a Brookfield DV-II+ Viscometer); pH 9.67 (measured at 25° C. using an Oakton 510 series pH/conductivity meter); conductivity 0.94 mScm⁻¹ (measured at 25° C. using an Oakton 510 series pH/conductivity meter); dynamic surface tension (measured using a SITA bubble pressure tensiometer): 40.6 mNm⁻¹ (measured at 25° C. and 11 Hz), 34.8 mNm⁻¹ (measured at 25° C. and 2.7 Hz), 31.0 mNm⁻¹ (measured at 25° C. and 0.1 Hz) and 30.6 mNm⁻¹ (measured at 25° C. and 0.025 Hz); UV absorbance at lambda max (sample diluted 2,500×) 0.3586 at 570 nm; resolubility measured using an in-house test <1 minute.

### Example 2B—Violet Ink (One Additional Polymer, 10% Polymeric Dye)

To a mechanically stirred tank or vessel using a magnetic stirrer bar is added deionised water, 5.60 g, propylene glycol, 5.20 g, dipropylene glycol, 1.0 g, Xiran 3000H (Polyscope Polymers Inc.; 25% (poly(styrene-maleamic acid) solution in water, acid number 255-305 mg KOH/g and molecular weight 10 kD), 5.0 g and finally Tego Wet KL 245, 0.2 g. 2.0 g (5% w/w) of the violet polymeric colorant, Evertint Violet R-01, was then added, followed by a further addition of deionised water, 1.0 g. The mixture was stirred for a further 1 hour at ambient temperature and then the mixture filtered through a 1-micron absolute glass fiber GF/B Whatman filter paper using vacuum. The physical properties of the ink when using Evertint Violet R-01 as the polymeric dye, were measured to give a viscosity of 10.8 cP (measured at 32° C. at low shear (i.e. at 60 rpm) using a Brookfield DV-II+ Viscometer); pH 9.69 (measured at 25° C. using an Oakton 510 series pH/conductivity meter); conductivity 0.812 mScm⁻¹ (measured at 25° C. using an Oakton 510 series pH/conductivity meter); dynamic surface tension (measured using a SITA bubble pressure tensiometer): 44.4 mNm⁻¹ (measured at 25° C. and 11 Hz), 38.0 mNm⁻¹ (measured at 25° C. and 2.7 Hz), 32.2 mNm⁻¹ (measured at 25° C. and 0.1 Hz) and 31.7 mNm⁻¹ (measured at 25° C. and 0.025 Hz); UV absorbance at lambda max (sample diluted 2,500×) 0.6967 at 570 nm; resolubility measured using an in-house test <1 minute.

### Example 3—Red Ink (One Additional Polymer, 5% Polymeric Dye)

To a mechanically stirred tank or vessel using a magnetic stirrer bar is added deionised water, 5.60 g, propylene glycol, 5.20 g, dipropylene glycol, 1.0 g, Xiran 3000H (Polyscope Polymers Inc.; 25% (poly(styrene-maleamic acid) solution in water, acid number 255-305 mg KOH/g and molecular weight 10 kD), 5.0 g and finally Tego Wet KL 245, 0.2 g. 1.0 g (5% w/w) of the red polymeric colorant, Evertint Red R-01, was then added, followed by a further addition of deionised water, 2.0 g. The mixture was stirred for a further 1 hour at ambient temperature and then the mixture filtered through a 1-micron absolute glass fiber GF/B Whatman filter paper using vacuum. The physical properties of the ink when using Evertint Red R-01 as the polymeric dye, were measured to give a viscosity of 5.11 cP (measured at 32° C. at low shear (i.e. at 60 rpm) using a Brookfield DV-II+ Viscometer); pH 9.67 (measured at 25° C. using an Oakton 510 series pH/conductivity meter); conductivity 0.937 mScm⁻¹ (measured at 25° C. using an Oakton 510 series pH/conductivity meter); dynamic surface tension (measured using a SITA bubble pressure tensiometer): 40.0 mNm⁻¹ (measured at 25° C. and 11 Hz), 34.6 mNm⁻¹ (measured at 25° C. and 2.7 Hz), 30.9 mNm⁻¹ (measured at 25° C. and 0.1 Hz) and 30.6 mNm⁻¹ (measured at 25° C. and 0.025 Hz); UV absorbance at lambda max (sample diluted 2,500×) 0.2502 at 530 nm; resolubility measured using an in-house test <1 minute.

### Example 4—Orange Ink (One Additional Polymer, 5% Polymeric Dye)

To a mechanically stirred tank or vessel using a magnetic stirrer bar is added deionised water, 5.60 g, propylene glycol, 5.20 g, dipropylene glycol, 1.0 g, Xiran 3000H (Polyscope Polymers Inc.; 25% (poly(styrene-maleamic acid) solution in water, acid number 255-305 mg KOH/g and molecular weight 10 kD), 5.0 g and finally Tego Wet KL 245, 0.2 g. 1.0 g (5% w/w) of the orange polymeric colorant, Evertint Orange R-01, was then added, followed by a further addition of deionised water, 2.0 g. The mixture was stirred for a further 1 hour at ambient temperature and then the mixture filtered through a 1-micron absolute glass fiber GF/B Whatman filter paper using vacuum. The physical properties of the ink when using Evertint Orange R-01 as the polymeric dye, were measured to give a viscosity of 5.36 cP (measured at 32° C. at low shear (i.e. at 60 rpm) using a Brookfield DV-II+ Viscometer); pH 9.72 (measured at 25° C. using an Oakton 510 series pH/conductivity meter); conductivity 0.917 mScm⁻¹ (measured at 25° C. using an Oakton 510 series pH/conductivity meter); dynamic surface tension (measured using a SITA bubble pressure tensiometer): 40.4 mNm⁻¹ (measured at 25° C. and 11 Hz), 34.5 mNm⁻¹ (measured at 25° C. and 2.7 Hz), 30.8 mNm⁻¹ (measured at 25° C. and 0.1 Hz) and 30.4 mNm⁻¹ (measured at 25° C. and 0.025 Hz); UV absorbance at lambda max (sample diluted 2,500×) 0.2859 at 480 nm; resolubility measured using an in-house test <1 minute.

### Example 5—Green Ink (One Additional Polymer, 5% Polymeric Dye)

To a mechanically stirred tank or vessel using a magnetic stirrer bar is added deionised water, 5.60 g, propylene glycol, 5.20 g, dipropylene glycol, 1.0 g, Xiran 3000H (Polyscope Polymers Inc.; 25% (poly(styrene-maleamic acid) solution in water, acid number 255-305 mg KOH/g and molecular weight 10 kD), 5.0 g and finally Tego Wet KL 245, 0.2 g. 1.0 g (5% w/w) of the green polymeric colorant, Reactint Green X8212 was then added, followed by a further addition of deionised water, 2.0 g. The mixture was stirred for a further 1 hour at ambient temperature and then the mixture filtered through a 1-micron absolute glass fiber GF/B Whatman filter paper using vacuum. The physical properties of the ink when using Reactint Green X8212 as the polymeric dye, were measured to give a viscosity of 4.76 cP (measured at 32° C. at low shear (i.e. at 60 rpm) using a Brookfield DV-II+ Viscometer); pH 8.97 (measured at 25° C. using an Oakton 510 series pH/conductivity meter); conductivity 1.486 mScm⁻¹ (measured at 25° C. using an Oakton 510 series pH/conductivity meter); dynamic surface tension (measured using a SITA bubble pressure tensiometer): 39.3 mNm⁻¹ (measured at 25° C. and 11 Hz), 33.5 mNm⁻¹ (measured at 25° C. and 2.7 Hz), 29.8 mNm⁻¹ (measured at 25° C. and 0.1 Hz) and 29.6 mNm⁻¹ (measured at 25° C. and 0.025 Hz); UV absorbance at lambda max (sample diluted 2,500×) 0.3477 at 630 nm; resolubility measured using an in-house test <1 minute.

### Example 6—Yellow Ink (One Additional Polymer, 5% Polymeric Dye)

To a mechanically stirred tank or vessel using a magnetic stirrer bar is added deionised water, 5.60 g, propylene glycol, 5.20 g, dipropylene glycol, 1.0 g, Xiran 3000H (Polyscope Polymers Inc.; 25% (poly(styrene-maleamic acid) solution in water, acid number 255-305 mg KOH/g and molecular weight 10 kD), 5.0 g and finally Tego Wet KL 245, 0.2 g. 1.0 g (5% w/w) of the green polymeric colorant, Reactint Yellow X15 was then added, followed by a further addition of deionised water, 2.0 g. The mixture was stirred for a further 1 hour at ambient temperature and then the mixture filtered through a 1-micron absolute glass fiber GF/B Whatman filter paper using vacuum. The physical properties of the ink when using Reactint Yellow X15 as the polymeric dye, were measured to give a viscosity of 5.32 cP (measured at 32° C. at low shear (i.e. at 60 rpm) using a Brookfield DV-II+ Viscometer); pH 9.11 (measured at 25° C. using an Oakton 510 series pH/conductivity meter); conductivity 1.411 mScm⁻¹ (measured at 25° C. using an Oakton 510 series pH/conductivity meter); dynamic surface tension (measured using a SITA bubble pressure tensiometer): 39.7 mNm⁻¹ (measured at 25° C. and 11 Hz), 34.0 mNm⁻¹ (measured at 25° C. and 2.7 Hz), 30.6 mNm⁻¹ (measured at 25° C. and 0.1 Hz) and 30.0 mNm⁻¹ (measured at 25° C. and 0.025 Hz); UV absorbance at lambda max (sample diluted 2,500×) 0.4202 at 430 nm; resolubility measured using an in-house test <1 minute.

### Example 7—Black Ink (One Additional Polymer, 5% Polymeric Dye)

To a mechanically stirred tank or vessel using a magnetic stirrer bar is added deionised water, 5.60 g, propylene glycol, 5.20 g, dipropylene glycol, 1.0 g, Xiran 3000H (Polyscope Polymers Inc.; 25% (poly(styrene-maleamic acid) solution in water, acid number 255-305 mg KOH/g and molecular weight 10 kD), 5.0 g and finally Tego Wet KL 245, 0.2 g. 1.0 g (5% w/w) of the black polymeric colorant, Reactint Black X77 was then added, followed by a further addition of deionised water, 2.0 g. The mixture was stirred for a further 1 hour at ambient temperature and then the mixture filtered through a 1-micron absolute glass fiber GF/B Whatman filter paper using vacuum. The physical properties of the ink when using Reactint Black X77 as the polymeric dye, were measured to give a viscosity of 4.95 cP (measured at 32° C. at low shear (i.e. at 60 rpm) using a Brookfield DV-II+ Viscometer); pH 9.11 (measured at 25° C. using an Oakton 510 series pH/conductivity meter); conductivity 1.421 mScm⁻¹ (measured at 25° C. using an Oakton 510 series pH/conductivity meter); dynamic surface tension (measured using a SITA bubble pressure tensiometer): 39.4 mNm⁻¹ (measured at 25° C. and 11 Hz), 33.7 mNm⁻¹ (measured at 25° C. and 2.7 Hz), 30.3 mNm⁻¹ (measured at 25° C. and 0.1 Hz) and 30.0 mNm⁻¹ (measured at 25° C. and 0.025 Hz); UV absorbance at lambda max (sample diluted 2,500×) 0.1289 at 550 nm, 0.1176 at 430 nm and 0.2094 at 630 nm; resolubility measured using an in-house test <1 minute.

All of the inventive Examples 1, 3, 4, 5, 6 inks were tested for the following properties to show their suitability for use as inkjet inks:

Printing Method & Curing Results

Ink Examples 1, 3, 4, 5 and 6 were printed onto various substrates and fabrics using a Dimatix SMP2800 benchtop printer. The fabrics are as follows: untreated cotton; untreated polyester-cotton (65-35) blend material; untreated PVC-based wallpaper material; coated polyester fabric (Polyester Brook FKPD8 (PE), and protected stainless steel. Results for stainless steel (referred to as laminated metal) can be found in Table 1.

The drop size used on the printer was 10 picolitres through a Dimatix DMC-11610 print cartridge. The drop spacing's used were 31 microns. The cartridge temperature was 32° C. and the meniscus set point at 4 inches of water. All 16 nozzles were firing and the throw distance was fixed at 2-3 mm. The inks were applied to the substrates using inkjet deposition from the Dimatix SMP2800 printer at a maximum jetting frequency of 2 kHz. For comparative purposes, drawdowns using an industrial coater were also made. The drawdown samples were prepared by using a no. 2 K-bar, automatic coating machine and a speed setting “11”. The polyester fabric was heat treated in a heat press at 200° C. for 120 seconds, the polyester-cotton blend and cotton were heat treated in a heat press at 160° C. for 120 seconds, the PVC wallpaper material was heat treated for 12 minutes at 130° C. in a fan oven and the laminated stainless steel was heat treated for 2 minutes at 130° C. and then 10 minutes at 210° C. in a fan oven. The color properties of the printed substrates were then measured demonstrating good adhesion to the substrates. In addition, cross hatch testing of the laminated metal (i.e. stainless steel) substrate indicated there was no peel off or flake off during the test, which demonstrates a robust coloured film had been produced.

Cross Hatch and Crock Test (Adhesion and Bend) on Coated and Printed Samples

Testing was performed on a coated steel substrate (white primer layer and clearcoat covering). The ink was applied to the substrate using either i) a 12-micron No. 2 K-bar (also known as a wire bar coater) or ii) inkjet printing. The inkjet printed film was applied to the substrate using a Dimatix DMP 2800 inkjet printer, using the K15 waveform. Drop size on the printer was 10 picolitres, with a cartridge temperature of 32° C., a meniscus setpoint of 4 inches of water, a drop spacing of 26 microns, from a DMC-11610 Dimatix print cartridge. A solid block of ink was inkjet printed in a 45 mm×45 mm block, with the cartridge aligned at 7 degrees to the direction of travel, a maximum jetting frequency of 2 kHz and a throw distance of 2-3 mm from the substrate. The resulting films were then dried at 110° C. for 2 minutes in fan oven. The sample was tested for scratch resistance using a fingernail. If no ink coating is visually removed, then the coating is a pass. The film was then cured in a convection oven for 10 minutes at 210° C. to ensure a full cure on a metal substrate. The bend test involves bending the substrate through 180 degrees and checking if there is any visible damage to the dried film by eye. If there is no damage, it is a pass. A cross-hatch test was then performed by using a scribe cross hatch (10×10 cross hatch). The print surface was wiped with a low friction contact brush and a strip of Elcometer 99 tape was applied to the crosshatch area and rubbed several times under pressure to ensure the tape is adhered to the surface. The tape end was bent over by 180 degrees and the tape end pulled to establish if any of the coating is removed. If any coating is removed, this is a fail. The films were also swabbed with deionized water up to 100 times by manual contact swabbing. A pass is at least 100 wipes. All of the Example 1, 3, 4, 5 and 6 inks passed all of these tests. These results indicate that the inventive inks containing polymeric dyes displayed excellent cross hatch and crock testing performance as comparative inks such as pigment inks.

TABLE 1
Adhesion data for the printed and cured films on laminated metal

| | | | | Cross- | water double |
|---|---|---|---|---|---|
| | | Scratch | Bend | hatch | rubs after |
| Example | Substrate | test | test | test | curing |
| 3 (Red) | Laminated | 100% | 100% | 100% | >100 |
| 4 (Orange) | Metal | 100% | 100% | 100% | >100 |
| 6 (Yellow) | | 100% | 100% | 100% | >100 |
| 5 (Green) | | 100% | 100% | 100% | >100 |
| 1 (Blue) | | 100% | 100% | 100% | >100 |

### Resolubility (Examples 1, 3-6 Inks)

A sample of each of the Example 1, 3-6 inks were coated on to a glass microscope slide (Fisher Scientific) using a 50-micron No. 5 K-bar (also known as a wire bar coater) and the film dried at 40° C. for 30 minutes in a fan convection oven. Subsequently, the printed substrate was partially immersed in a beaker containing flush (inkjet flush liquid) and the time taken for the ink to resolubilize from the substrate was recorded. For this test, the time to resolubilize is preferably <2 hours, more preferably <1 hour, more preferably <30 min., most preferably <10 min. In all cases, the inks resolubilized in <1 minute, which is an excellent result. This test is an accurate representation of what might happen to an inkjet print head if it is not capped correctly and is left for a long period of time with the end result being the ink drying in the print head or the machine. The expectation is that the ink should be resolubilized as quickly as possible with no visible or lasting damage to the print head or machine. The inventive inks containing polymeric dyes and acid functional binder polymers showed the expected level of performance compared to standard dye-based inks and superior performance to pigment-based inks.

Storage Stability

All of the Example 1-6 inks were tested for storage stability by storing the ink samples in glass vials (30 mL) for periods of time at 50° C. The physical properties listed in the examples were measured on a weekly basis. If one of the parameters from viscosity, surface tension, pH or conductivity has changed by more than +/−10% over the course of 2 weeks, then the ink is deemed to have failed. Examples 1-6 inks all showed acceptable stability (no change of +/−10% for the aforementioned properties) after two weeks at 50° C. This equates to a product shelf-life of approximately 16 weeks at normal storage conditions (15-30° C.). These results indicate that the inventive inks containing polymeric dyes displayed similar stability as comparative inks containing dyes only and superior performance to pigment-based inks.

Degree of Fixation on Textile Fabrics on Coated Samples

Testing was performed on 100% untreated cotton, Polyester Brook FKPD8 (PE) and 100% lint-free cotton wipes from RS (which are also untreated). For comparative purposes, reference control fluids were prepared by taking the respective color of reactive dye inkjet ink (SunTex+Xennia Amethyst range) and diluting the ink in a 1:2 ratio with deionized water giving an overall dye concentration of approximately 4%. These were labelled as control inks A. A second reference fluid was prepared by taking the polymeric dye (Everlight or Milliken) and preparing a 5% solution of the polymeric dye in deionized water. This has then an equivalent polymeric dye loading to the inks 1-6. These were labelled as control inks B. The inks and controls were applied to the substrates using either a 12-micron No. 2 K-bar (also known as a wire bar coater). The resulting drawdown samples were then allowed to air dry for about 10 minutes, and were then cured in a heat press for 120 seconds at a temperature of 160° C. The substrates were then immersed in a 1% solution of Tergitol TMN in deionized water and left to soak with gentle agitation for 10 minutes at room temperature. The resulting supernatant liquid was then decanted and the substrate washed in warm water until there is no more coloration evolving under the stream of water. The substrates were then allowed to dry at room temperature and a visual determination of the percentage level of fixation was made. In all cases, the inventive inks demonstrated superior fixation and coloration to both reactive dye inks (control inks A) at a similar colorant loading or the control liquids B. This demonstrates that the inventive inks can be printed with superior washfastness on substrates which do not require a pre-treatment, which is a further advantage of these inks and limits the amount of environmental pollution and wastage.

Cyan/Blue-Ink Example 1 vs. Control Inks A and B

| | Cotton 100% | Brook PE | Cotton Wipes (RS) |
|---|---|---|---|
| Ink | (% wash-off) | (% wash-off) | (% wash-off) |
| Blue Ink 1 | 20% | 30% | 20% |
| Cyan Control Ink A | 50% | 100% | 40% |
| Blue Control Ink B | 95% | 100% | 90% |

Magenta/Red-Ink Example 3 vs. Control Inks A and B

| | Cotton 100% | Brook PE | Cotton Wipes (RS) |
|---|---|---|---|
| Ink | (% wash-off) | (% wash-off) | (% wash-off) |
| Red Ink 3 | 10% | 30% | 10% |
| Magenta Control Ink A | 30% | 100% | 50% |
| Red Control Ink B | 80% | 100% | 90% |

### Definitions

Good jetting and printed image quality is defined as adequate drop formation when ejected from a digital inkjet head at different drop volumes. There should be no satellites or drop break up which can be detrimental to the printed image quality, usually verified by jet testing on a drop watcher machine such as those from X-Rite. Good printed image quality is defined as the image being compliant with the end use application. Usually verified using a series of tests such as line straightness, wicking, feathering, dot gain, etc. on an ImageXpert from Xrite.

Storage stability is the number of days, weeks or months that an ink can be stored without any significant settling or degradation which may lead to poorer performance of the inks.

Open time is the time by which a print head can be left uncapped (hence open) and then when jetting is recommenced, a complete start-up of all nozzles. Normal open times are at least one hour.

Resolubility is defined as the time taken to resolubilise ink which has air dried in a digital print head or press due to poor maintenance or downtime. The expectation is that when using a standard flush, cleaning or maintenance liquid, the ink is resolubilised in less than 10 minutes, thus enabling blocked nozzles to be recovered.

1. A printing ink comprising one or more solution soluble polymeric colorant(s), one or more acid functional polymer(s), water and one or more organic co-solvent(s); wherein the polymeric colorant(s) comprises polymer chains having at least one hydroxyl (—OH), thiol (—SH) or primary or secondary amino (—NH2 or —NHR) group on the polymer chain; wherein the inks are suitable for inkjet deposition, wherein the one or more acid functional polymer(s) is a poly(styrene-maleic acid) copolymer, a poly (styrene-maleamic acid) copolymer or a combination thereof.

2. The ink of claim 1, wherein the one or more acid functional polymer(s) are selected from the group consisting of styrene/acrylic acid copolymers, styrene/maleic acid copolymers, styrene/maleamic acid copolymers, styrene/maleic acid/alkyl acrylate copolymers, styrene/methacrylic acid copolymers, styrene/methacrylic acid/alkyl acrylate copolymers, styrene/maleic half ester copolymers, vinyl naphthalene/acrylic acid copolymers, vinyl naphthalene/maleic acid copolymers, polyacrylics, salts thereof and blends thereof.

3. The ink of claim 2, further comprising one or more material(s) selected from the group consisting of surfactants, wetting agents and biocides.

4. The ink of claim 3, wherein the polymeric colorant contains polymer chains having at least one hydroxyl (—OH) group, primary or secondary amino (—NH2 or —NHR) group, thiol (—SH) group, or combinations thereof.

5-6. (canceled)

7. The ink of claim 4, wherein the only polymers incorporated into the ink are the polymeric colorant and the acid functional polymer.

8. (canceled)

9. The ink of claim 4, further comprising an additional polymer selected from the group consisting of polyvinyl alcohols, polyesters, polyestermelamines, styrene/acrylic acid copolymers, styrene/maleic acid/alkyl acrylate copolymers, styrene/methacrylic acid copolymers, styrene/methacrylic acid/alkyl acrylate copolymers, styrene/maleic half ester copolymers, vinyl naphthalene/acrylic acid copolymers, vinyl naphthalene/maleic acid copolymers, polyacrylics, polyurethanes, hydroxyl functional polymers and salts thereof.

10. The ink of claim 2, wherein the acid functional polymer is a salt having counterions selected from the group consisting of lithium, sodium, potassium, ammonium, hydrogen, quaternary ammonium salts of organic amines and blends thereof.

11. The ink of claim 10 wherein the organic amine of the quaternary ammonium salts of organic amines is selected from the group consisting of primary, secondary and tertiary aliphatic amines or hydroxyl- or alkoxyl amines and blends thereof.

12. The ink of claim 11, further comprising a cross-linking agent selected from the group consisting of carbodimide, aziridine, organosilanes and blends thereof.

13. (canceled)

14. The ink of claim 12, wherein the polymeric colorant may contain a dye, an organic pigment, an inorganic pigment or the lake pigment of a dye.

15. The ink of claim 14, wherein the polymeric colorant comprises a colorant selected from the group consisting of yellow, black, cyan, magenta, orange, red, blue, green, white, violet and blends thereof.

16. The ink of claim 12 further comprising one or more pigment(s).

17-18. (canceled)

19. The ink of claim 16, comprising 0.1-15.0 wt % of a polymeric colorant, 0.1-15 wt % of acid functional polymer, 2-30 wt % of an organic solvent, 0.01-5 wt % of a surfactant and water.

20-22. (canceled)

23. The ink of claim 19 wherein the organic co-solvent is propylene glycol, dipropylene glycol or a combination thereof.

24. The ink of claim 23, wherein the acid number of the acid functional polymer is ≥255 mg KOH/g.

25-28. (canceled)

29. A printed substrate comprising or derived from the ink of claim 1.

30. A method of printing, comprising depositing the ink of claim 1 onto a substrate.

31. The method of claim 30, wherein the method of printing is inkjet printing.

32. The method of claim 31, wherein the substrate is selected from the group consisting of textiles, leather, wood, cardboard, fiberboard, wall papers, steel, copper, protected metals and polyesters.

33-39. (canceled)

40. Use of a printing ink for printing an image on a substrate by inkjet printing, wherein the ink comprises one or more solution soluble polymeric colorant(s), one or more acid functional polymer(s), water and one or more organic co-solvent(s); wherein the polymeric colorant(s) comprises polymer chains having at least one hydroxyl (—OH), thiol (—SH) or primary or secondary amino (—NH2 or —NHR—) group on the polymer chain, wherein the one or more acid functional polymer(s) is a poly(styrene-maleic acid) copolymer, a poly (styrene-maleamic acid) copolymer or a combination thereof.

41-45. (canceled)
